(19) United States
(12) Patent Application Publication
(10) Pub. No.: US 2025/0227595 A1
(43) Pub. Date: Jul. 10, 2025

(54) CELL RESELECTION METHOD, USER EQUIPMENT, SYSTEM, NON-TRANSITORY COMPUTER-READABLE MEDIUM AND CHIPSET

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi (JP); Tuchjuta RUCKKWAEN, Yokohama-shi (JP)

(73) Assignee: KYOCERA Corporation, Kyoto (JP)

(21) Appl. No.: 19/093,664

(22) Filed: Mar. 28, 2025

Related U.S. Application Data
(63) Continuation of application No. PCT/JP2023/035277, filed on Sep. 27, 2023.
(60) Provisional application No. 63/411,245, filed on Sep. 29, 2022.

(51) Int. Cl. H04W 36/36; H04W 36/06

(52) U.S. Cl. CPC H04W 36/36; H04W 36/06

(57) ABSTRACT

A cell reselection method used in a user equipment includes the steps of: performing slice-based cell reselection in response to the user equipment receiving, from a network node, slice-specific cell reselection information indicating a cell reselection priority of each slice group and each frequency; and determining whether highest priority processing is applicable based on whether the slice-based cell reselection to which the slice-specific cell reselection information is applied is being performed, the highest priority processing regarding a frequency or a cell for providing a predetermined feature different from the slice-based cell reselection as a highest priority of cell reselection.

### RELATED APPLICATIONS

The present application is a continuation based on PCT Application No. PCT/JP2023/035277, filed on Sep. 27, 2023, which claims the benefit of U.S. Provisional Patent Application No. 63/411,245 filed on Sep. 29, 2022. The content of which is incorporated by reference herein in their entirety.

### TECHNICAL FIELD

The present disclosure relates to a cell reselection method used in a mobile communication system.

### BACKGROUND

The 3rd Generation Partnership Project (3GPP) defines technical specifications of a slice-based cell reselection feature that supports network slices (e.g., see Non-Patent Document 1).

### CITATION LIST

### Non-Patent Literature

Non-Patent Document 1: 3GPP Technical Specification: TS 38.304 V17.1.0

### SUMMARY

In a first aspect, a cell reselection method is a cell reselection method used in a user equipment, the cell reselection method including the steps of: performing slice-based cell reselection in response to the user equipment receiving, from a network node, slice-specific cell reselection information indicating a cell reselection priority of each slice group and each frequency; and determining whether highest priority processing is applicable based on whether the slice-based cell reselection to which the slice-specific cell reselection information is applied is being performed, the highest priority processing regarding a frequency or a cell for providing a predetermined feature different from the slice-based cell reselection as a highest priority of cell reselection.

In a second aspect, a cell reselection method is a cell reselection method used in a user equipment, the cell reselection method including the steps of: performing slice-based cell reselection to which slice-specific cell reselection is applied, in response to a user equipment receiving, from a network node, the slice-specific cell reselection information indicating a cell reselection priority of each slice group and each frequency; and acquiring, from the network node or a Non-Access Stratum (NAS), configuration information for configuring whether highest priority processing is applicable, the highest priority processing regarding a frequency or a cell for providing a predetermined feature different from the slice-based cell reselection as a highest priority of cell reselection.

In a third aspect, a cell reselection method is a cell reselection method used in a user equipment, the cell reselection method including the steps of: transmitting, to a network, preference information indicating a preference of a user equipment as to which of slice-based cell reselection or a predetermined feature different from the slice-based cell reselection to prioritize for cell reselection; and controlling the slice-based cell reselection and highest priority processing according to configuration information received from the network based on the preference information, the highest priority processing regarding a frequency or a cell for providing the predetermined feature as a highest priority of cell reselection.

In a fourth aspect, a cell reselection method is a cell reselection method used in a user equipment, the cell reselection method including the steps of: acquiring priority slice group information indicating a priority slice group from a Non-Access Stratum (NAS); checking whether information indicating a predetermined feature different from the slice-based cell reselection is included in any one of slice groups indicated by the priority slice group information; and regarding the slice group including the information indicating the predetermined feature or a frequency for providing the predetermined feature as a highest priority of cell reselection, in response to the information indicating the predetermined feature being included in any one of the slice groups.

In a fifth aspect, a cell reselection method is a cell reselection method used in a user equipment, the cell reselection method including the steps of: acquiring priority slice group information indicating a priority slice group from a Non-Access Stratum (NAS); executing a predetermined feature different from the slice-based cell reselection; receiving, from a network node, slice-specific cell reselection information indicating a cell reselection priority of each slice group and each frequency; and regarding a frequency for providing the predetermined feature as a highest priority of cell reselection among frequencies for which the cell reselection priority is configured in the slice-specific cell reselection information for a highest priority slice group indicated by the priority slice group information.

### BRIEF DESCRIPTION OF THE DRAWINGS

FIG. 1 is a diagram illustrating a configuration of a mobile communication system according to an embodiment.

FIG. 2 is a diagram illustrating a configuration of a User Equipment (UE) according to the embodiment.

FIG. 3 is a diagram illustrating a configuration of a gNB (base station) according to the embodiment.

FIG. 4 is a diagram illustrating a configuration of a protocol stack of a radio interface of a user plane that handles data.

FIG. 5 is a diagram illustrating a configuration of a protocol stack of a radio interface of a control plane that handles signaling (control signal).

FIG. 6 is a diagram for describing a typical cell reselection procedure.

FIG. 7 is a diagram illustrating a schematic flow of the typical cell reselection procedure.

FIG. 8 is a diagram illustrating an example of network slicing.

FIG. 9 is a diagram for describing an overview of slice-based cell reselection.

FIG. 10 is a diagram illustrating an example of slice-specific cell reselection information.

FIG. 11 is a diagram illustrating an operation example of the UE according to a first operation pattern.

FIG. 12 is a diagram illustrating an operation example of the mobile communication system according to a second operation pattern.

FIG. 13 is a diagram illustrating an operation example of the mobile communication system according to a third operation pattern.

FIG. 14 is a diagram illustrating an operation example of the UE according to a fourth operation pattern.

FIG. 15 is a diagram illustrating an operation example of the UE according to a fifth operation pattern.

### DESCRIPTION OF EMBODIMENTS

A mobile communication system according to an embodiment will be described with reference to the drawings. In the description of the drawings, the same or similar parts are denoted by the same or similar reference signs.

### (1) System Configuration

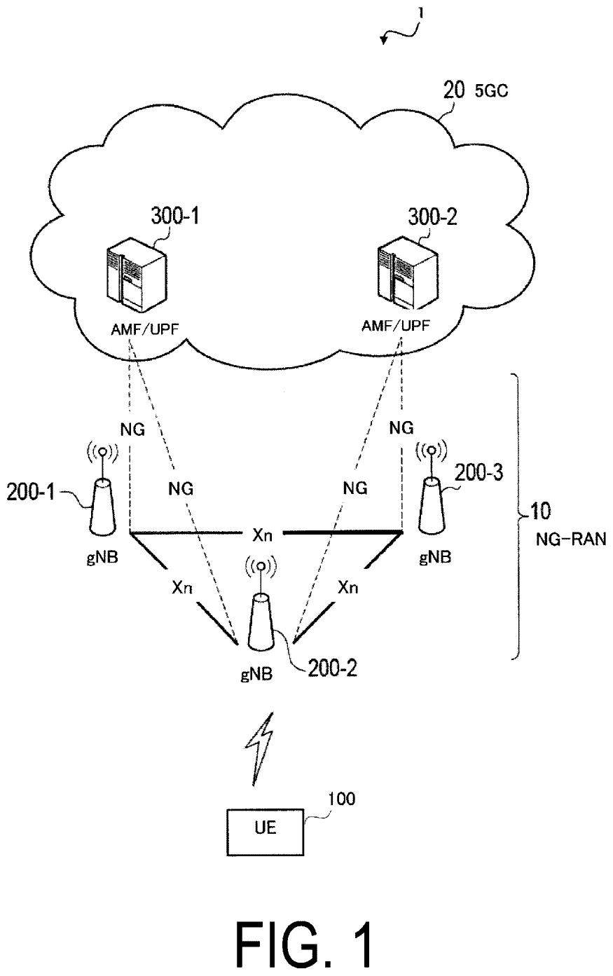

First, a configuration of a mobile communication system 1 according to the embodiment will be described. FIG. 1 is a diagram illustrating the configuration of the mobile communication system 1 according to the embodiment. The mobile communication system 1 complies with the 5th Generation System (5GS) of the 3GPP standards. The description below takes the 5GS as an example, but a Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 will be also referred to simply as the RAN 10. The 5GC 20 will be also referred to simply as the Core Network (CN) 20. The RAN 10 and the CN 20 constitute a network of the mobile communication system 1.

The UE 100 is a movable wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a Radio Resource Management (RRM) feature, a feature of routing user data (hereinafter referred to simply as “data”), a measurement control feature for mobility control and scheduling, and the like. The “cell” is used as a term indicating a minimum unit of a wireless communication area. The “cell” is also used as a term indicating a feature or a resource for performing wireless communication with the UE 100. One cell belongs to one carrier frequency (hereinafter referred to simply as a “frequency”).

Note that the gNB can be also connected to an Evolved Packet Core (EPC) corresponding to a core network of LTE. An LTE base station can be also connected to the 5GC. The LTE base station and the gNB can be also connected via an inter-base station interface.

The 5GC 20 includes an Access and Mobility Management feature (AMF) and a User Plane Feature (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

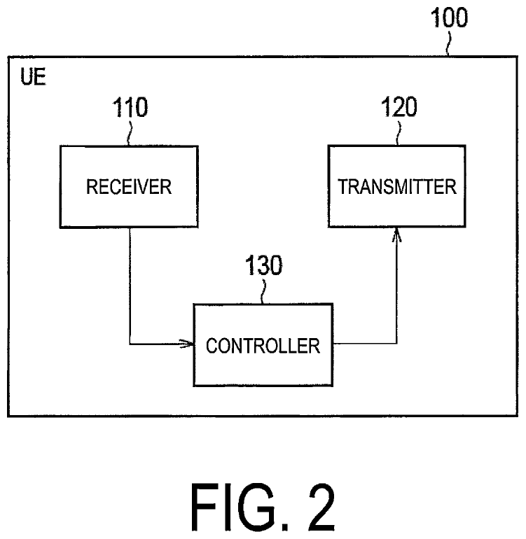

FIG. 2 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (received signal), and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal, and transmits the radio signal through the antenna.

The controller 130 performs various types of control and processing in the UE 100. Such processing includes processing of respective layers to be described below. The above-described and below-described operations of the UE 100 may be operations performed under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory and performs various types of processing.

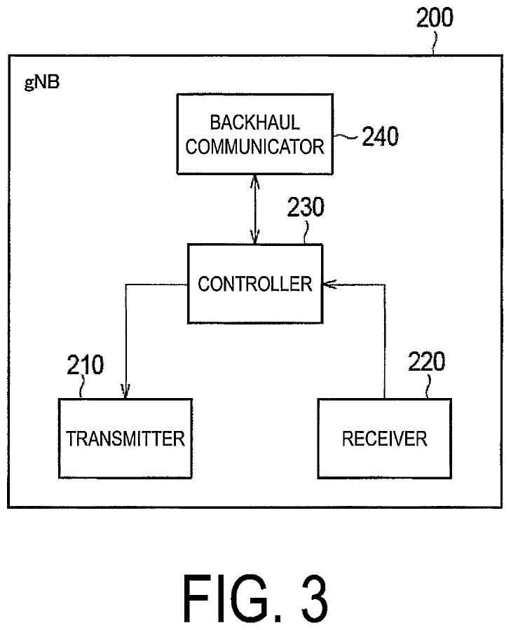

FIG. 3 is a diagram illustrating a configuration of the gNB 200 (base station) according to the embodiment. The gNB 200 includes a transmitter 210, a receiver 220, the controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal, and transmits the radio signal through the antenna.

The receiver 220 performs various types of reception under control of the controller 230. The receiver 220 includes an antenna and a reception device. The reception device converts a radio signal received through the antenna into a baseband signal (received signal), and outputs the baseband signal to the controller 230.

The controller 230 performs various types of control and processing in the gNB 200. Such processing includes processing of respective layers to be described below. The above-described and below-described operations of the gNB 200 may be operations performed under control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing.

The backhaul communicator 240 is connected to a neighboring base station via an Xn interface that is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., features are divided), and both units may be connected via an F1 interface that is a fronthaul interface.

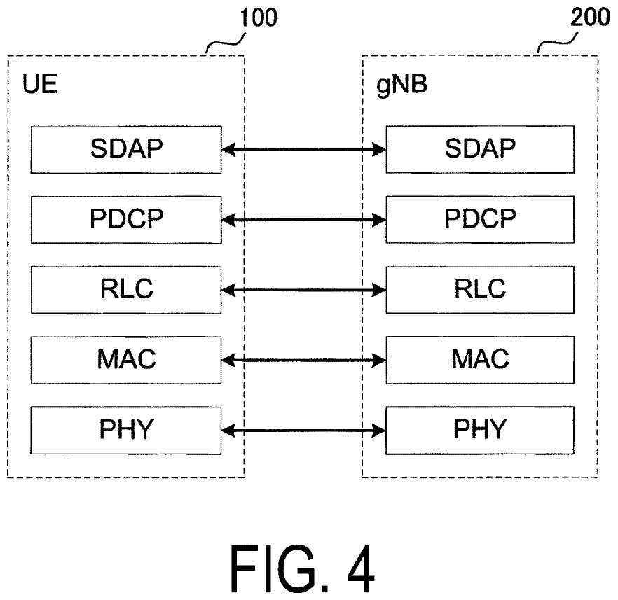

FIG. 4 is a diagram illustrating a configuration of a protocol stack of a radio interface of a user plane that handles data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind-decodes the PDCCH using a Radio Network Temporary Identifier (RNTI), and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using features of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP may not be provided.

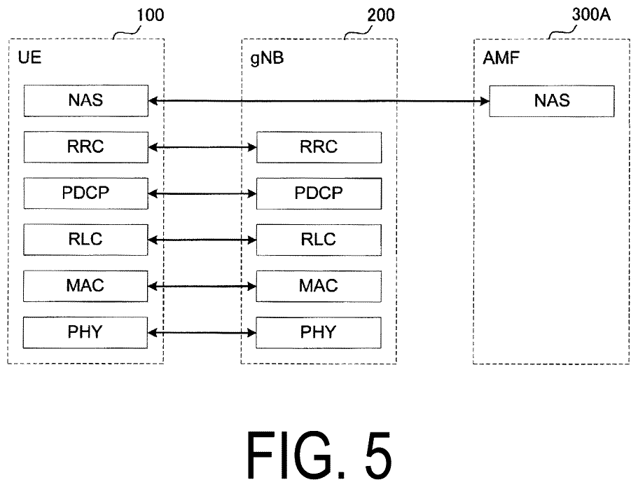

FIG. 5 is a diagram illustrating a configuration of a protocol stack of a radio interface of a control plane that handles signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and the RRC of the gNB 200, the UE 100 is in an RRC connected state. When no connection (RRC connection) is established between the RRC of the UE 100 and the RRC of the gNB 200, the UE 100 is in an RRC idle state. When connection between the RRC of the UE 100 and the RRC of the gNB 200 is suspended, the UE 100 is in an RRC inactive state.

The NAS layer (also referred to simply as an “NAS”) that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. Each layer lower than the NAS layer is referred to as an AS layer (also referred to simply as an “AS”).

### (2) Slice-Based Cell Reselection

Slice-based cell reselection according to the embodiment will be described.

### (2.1) Typical Cell Reselection Procedure

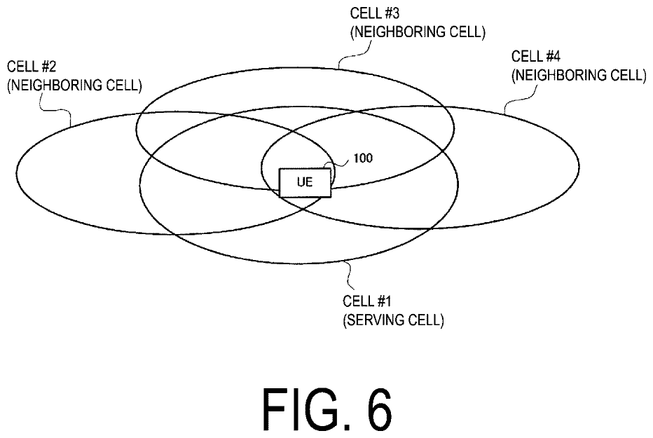

FIG. 6 is a diagram for describing a typical cell reselection procedure. The UE 100 in the RRC idle state or the RRC inactive state performs the cell reselection procedure to migrate from a current serving cell (cell #1) to a neighboring cell (any one of cells #2 to #4) as the UE 100 migrates. More specifically, the UE 100 specifies a neighboring cell on which the UE needs to camp by the cell reselection procedure, and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

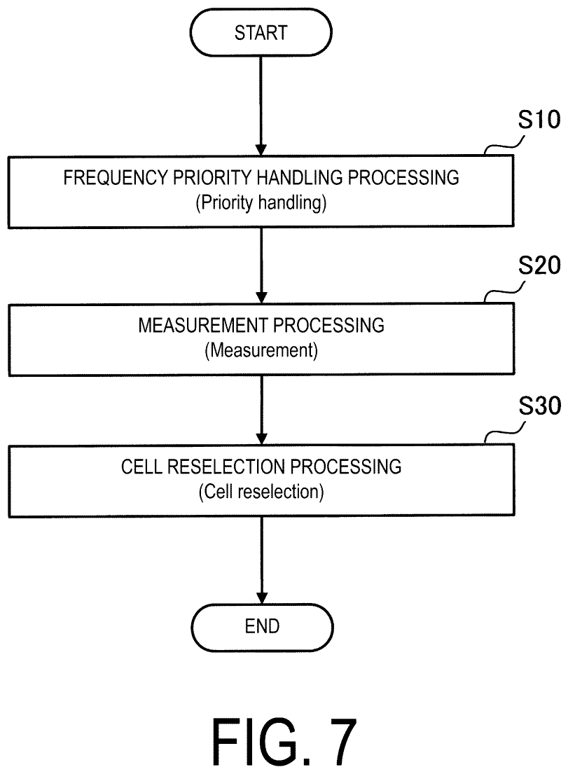

FIG. 7 is a diagram illustrating a schematic flow of the typical cell reselection procedure.

In step S10, the UE 100 performs frequency priority handling processing based on a priority of each frequency (also referred to as an “absolute priority” or a “cell reselection priority”) designated by the gNB 200 by, for example, a System Information Block (SIB) or an RRC release message. More specifically, the UE 100 manages the frequency priority designated by the gNB 200 per frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 measures the radio quality of the frequencies having higher priorities than a priority of the frequency of the current serving cell at all times, and, as for frequencies having priorities equal to or lower than the priority of the frequency of the current serving cell, measures the radio quality of the frequencies having priorities equal to or lower than the priority of the frequency of the current serving cell when the radio quality of the current serving cell goes below a predetermined quality.

In step S30, the UE 100 performs the cell reselection processing of reselecting a cell that the UE 100 camps on based on the measurement result in step S20. For example, when the priority of a frequency of a neighboring cell is higher than the priority of the current serving cell and the neighboring cell satisfies a predetermined quality standard (i.e., minimal required quality standard) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells, and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold, and the radio qualities of the neighboring cells are continuously higher than another threshold for the predetermined period of time, the UE 100 may perform cell reselection for the neighboring cell.

### (2.2) Network Slicing

Network slicing is a technique of creating a plurality of virtual networks by virtually dividing a physical network (e.g., a network including the NG-RAN 10 and the 5GC 20) constructed by a telecommunications carrier. Each virtual network is referred to as a network slice. Hereinafter, a network slice will be also referred to simply as a “slice”.

Network slicing allows a telecommunications carrier to create slices according to service requirements of different service types such as enhanced Mobile Broadband (eMBB), Ultra-Reliable and Low Latency Communications (URLLC), and massive Machine Type Communications (mMTC), and optimize network resources.

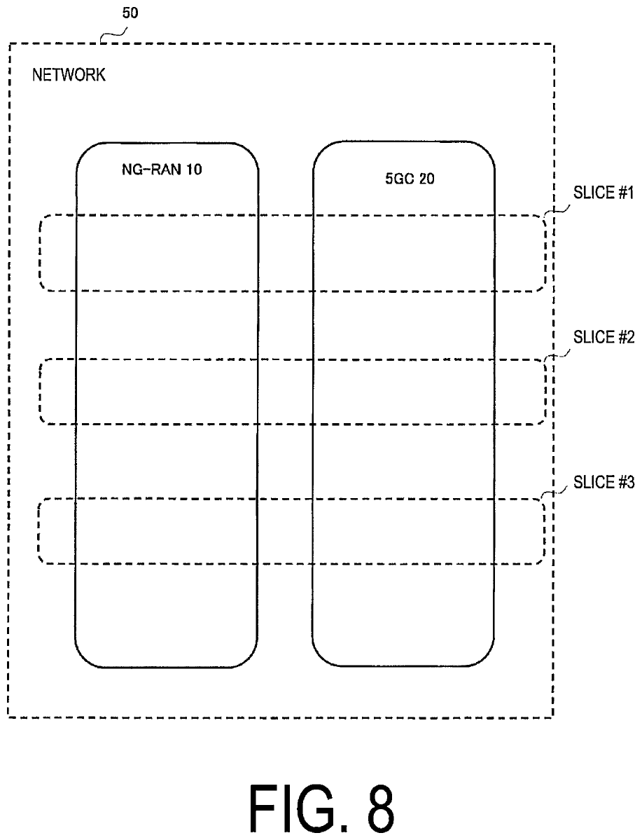

FIG. 8 is a diagram illustrating an example of the network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Note that three or more slices may be configured on the network 50. One service type may be associated with a plurality slices.

Each slice is provided with a slice identifier for identifying the slice. Examples of the slice identifier include Single Network Slicing Selection Assistance Information (S-NSSAI). The S-NSSAI includes an 8-bit Slice/Service Type (SST). The S-NSSAI may further include a 24-bit Slice Differentiator (SD). The SST is information indicating a service type with which a slice is associated. The SD is information for differentiating a plurality of slices associated with the same service type. The information including a plurality of pieces of S-NSSAI is referred to as Network Slice Selection Assistance Information (NSSAI).

One or more slices may be grouped to configure a slice group. A slice group is a group including one or more slices, and a slice group identifier is assigned to the slice group. The slice group will be referred to as a Network Slice AS Group (NSAG).

### (2.3) Overview of Slice-Based Cell Reselection

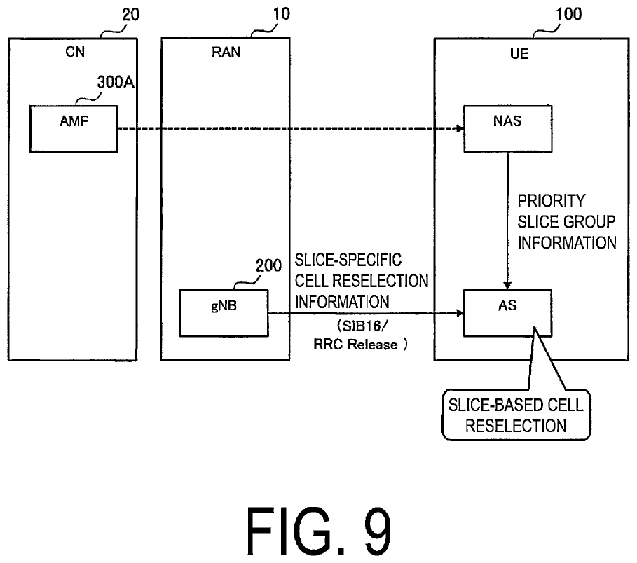

FIG. 9 is a diagram for describing the overview of slice-based cell reselection.

The gNB 200 includes slice-specific cell reselection information in an SIB 16 and/or an RRC Release message defined by RRC to transmit to the UE 100. The slice-specific cell reselection information may include a reselection priority of each frequency and each NSAG, and a list of cells for which a slice of the NSAG is supported or not supported. In the UE 100, the NAS provides the AS with priority NSAG information (also referred to as “priority slice group information”) including the NSAG and a NAS priority (a priority to be taken into account at a time of cell reselection).

When the UE 100 supports slice-based cell reselection and the slice-specific cell reselection information is provided from the gNB 200 to the UE 100 (AS), the UE 100 uses the slice-specific cell reselection information. When slice-specific cell reselection information is not provided to the UE 100 from the gNB 200 for any NSAG that the AS has obtained from the NAS and is not taken into account during cell reselection, the UE 100 uses typical cell reselection information that is not slice-specific.

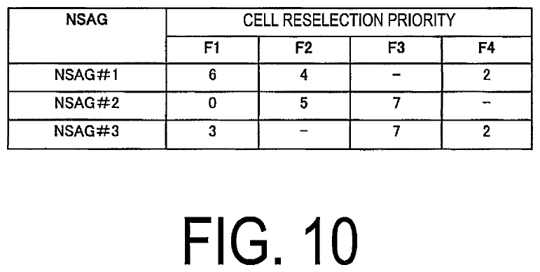

The slice-specific cell reselection information includes information indicating a correspondence between the NSAG, the frequency, and the cell reselection priority. For example, the slice-specific cell reselection information indicates, for each NSAG, a frequency (one or more frequencies) that supports the NSAG, and a cell reselection priority (also referred to as “slice-specific cell reselection priority”) assigned to each frequency. FIG. 10 illustrates an example of the slice-specific cell reselection information. A number indicated by “#” in FIG. 10 may be an NSAG identifier.

In the example illustrated in FIG. 10, three frequencies that are frequencies F1, F2, and F4 are associated with an NSAG #1 as frequencies that support the NSAG #1. Among these three frequencies, a slice-specific cell reselection priority of F1 is “6”, a slice-specific cell reselection priority of F2 is “4”, and a slice-specific cell reselection priority of F4 is “2”. It is assumed in the example in FIG. 10 that the slice-specific cell reselection priority is one of 0 to 7, and a larger number indicates a higher priority.

Three frequencies that are frequencies F1, F2, and F3 are associated with an NSAG #2 as frequencies that support the NSAG #2. Among these three frequencies, a slice-specific cell reselection priority of F1 is “0”, a slice-specific cell reselection priority of F2 is “5”, and a slice-specific cell reselection priority of F3 is “7”.

The three frequencies that are the frequencies F1, F3, and F4 are associated with an NSAG #3 as frequencies that support the NSAG #3. Among these three frequencies, the slice-specific cell reselection priority of F1 is “3”, the slice-specific cell reselection priority of F3 is “7”, and the slice-specific cell reselection priority of F4 is “2”.

### (3) Highest Priority Processing During Cell Reselection

The highest priority processing during cell reselection according to the embodiment will be described.

The UE 100 performs highest priority processing of regarding, as the highest priority of cell reselection, frequencies or cells for providing predetermined features different from slice-based cell reselection. The highest priority may be a priority higher than 0 to 7 that is a cell reselection priority (also referred to as a “priority configured by a network”) that can be configured from the network to the UE 100.

For example, the predetermined feature to which the highest priority processing is applied includes Multicast/Broadcast Services (MBS), sidelink communication, and a High Speed Dedicated Network (HSDN). It is assumed in the embodiment that the UE 100 supports at least one feature selected from the group consisting of the MBS, the sidelink communication, and the HSDN. Note that the sidelink communication may include sidelink discovery.

The UE 100 that supports the MBS and is in an RRC idle state or an RRC inactive state applies following changes to normal cell reselection rules. More specifically, when the UE 100 that is receiving or is interested in receiving MBS broadcast services via Point-to-Multipoint (PTM) can receive these MBS broadcast services only by camping on a frequency for providing these MBS broadcast services, the UE 100 is permitted to make these frequencies the highest priority (higher than the priorities configured by other networks). When the MBS broadcast service that the UE 100 is interested in is no longer available (after an end of a session), or when the UE 100 is no longer interested in receiving the broadcast service, the UE 100 no longer prioritizes the frequency. The UE 100 that is receiving or is interested in receiving the MBS broadcast services via PTM is permitted to make frequencies at which these MBS broadcast services cannot be received the lowest priority (lower than the priorities configured by the other networks).

When executing cell reselection in the RRC idle state or the RRC inactive state, the UE 100 that supports sidelink communication and is interested in V2X services may take into account whether NR sidelink communication and/or V2X sidelink communication is supported by a cell. The UE 100 may regard a next carrier frequency as a frequency of the highest priority (higher than priorities configured by the other networks):
Frequencies for providing both of an NR sidelink communication configuration and a V2X sidelink communication configuration when execution of both of the NR sidelink communication and the V2X sidelink communication is configured,
Frequencies for providing the NR sidelink communication configuration when execution of only the NR sidelink communication is configured, and
Frequencies for providing the V2X sidelink communication configuration when execution of only the V2X sidelink communication is configured.

The UE 100 that supports the HSDN and is in the RRC idle state or the RRC inactive state and in a fast moving state regards the HSDN cell as the highest priority (higher than the priorities configured by the other networks) at all times. The UE 100 that is not in the fast moving state regards the HSDN cell as the lowest priority (lower than priorities configured by the other networks) at all times.

### (4) Operation According to Embodiment

As described above, during slice-based cell reselection, the AS of the UE 100 is configured with the priority slice group information (NSAG priority) from the NAS (the AMF 300A from another viewpoint), and is configured with the slice-specific cell reselection priority from the gNB 200. The AS of the UE 100 performs slice-based cell reselection by applying a slice-specific cell reselection priority associated with a priority NSAG as the cell reselection priority.

On the other hand, using the features (services) of the sidelink, the HSDN, and the MBS, the UE 100 can perform the highest priority processing of regarding frequencies for providing the features (services) as the highest priority according to various states. Such highest priority processing may have a problem of conflict with the cell reselection priority determined during slice-based cell reselection. When, for example, regarding an MBS frequency as the highest priority, the UE 100 performs cell reselection using a cell reselection priority different from the slice-specific cell reselection priority.

First to fifth operation patterns according to the embodiment will be described below. It is assumed that the UE 100 is in the RRC idle state or the RRC inactive state except when communicating dedicated signaling (e.g., an RRC Release message or an RRC Reconfiguration message) with the network. Any one operation pattern of the first to fifth operation patterns may be performed alone, or two or more operation patterns may be combined and performed.

### (4.1) First Operation Pattern

According to the first operation pattern according to the embodiment, the UE 100 (AS) performs slice-based cell reselection in response to reception of slice-specific cell reselection information indicating a cell reselection priority of each NSAG and each frequency from the gNB 200. Based on whether slice-based cell reselection to which the slice-specific cell reselection information is applied is being performed, the UE 100 (AS) determines whether the highest priority processing of regarding, as the highest priority of cell reselection, a frequency or a cell for providing a predetermined feature (the sidelink, the HSDN, or the MBS) is applicable.

More specifically, when applying the slice-specific cell reselection priority included in the slice-specific cell reselection information provided by the gNB 200, the UE 100 (AS) is not permitted to regard any frequency as the highest priority. That is, when the UE 100 (AS) applies the slice-specific cell reselection priority included in the slice-specific cell reselection information provided by the gNB 200, the highest priority processing is disabled (i.e., prohibited).

The UE 100 (AS) acquires priority NSAG information indicating a priority NSAG from the NAS. When the UE 100 (AS) acquires the priority NSAG information from the NAS, yet does not receive the slice-specific cell reselection information (slice-specific cell reselection priority) from the gNB 200, the UE 100 (AS) may determine that the highest priority processing can be applied (i.e. enabled), and apply the highest priority processing. When the UE 100 (AS) does not receive the slice-specific cell reselection information (slice-specific cell reselection priority) from the gNB 200, the UE 100 (AS) cannot perform slice-based cell reselection. Therefore, even when the priority NSAG information is configured from the NAS to the AS, and when the UE 100 (AS) does not receive the slice-specific cell reselection information (slice-specific cell reselection priority) from the gNB 200, application of the highest priority processing is enabled. Thus, it is easy for the UE 100 to use a desired feature by the highest priority processing. When the UE 100 (AS) does not acquire the priority NSAG information from the NAS, and even when the UE 100 (AS) receives the slice-specific cell reselection information (slice-specific cell reselection priority) from the gNB 200, the UE 100 (AS) may determine that the highest priority processing can be applied (i.e. enabled), and apply the highest priority processing. When not acquiring the priority NSAG information from the NAS, the UE 100 (AS) cannot perform slice-based cell reselection. Hence, when the priority NSAG information is not configured from the NAS to the AS, and even when the UE 100 (AS) receives the slice-specific cell reselection information (slice-specific cell reselection priority) from the gNB 200, application of the highest priority processing is enabled.

The highest priority processing according to this operation pattern may be enabled/disabled targeting at all features of the sidelink, the HSDN, and the MBS (that is, all features are commonly enabled/disabled), or separately for each feature (that is, each feature is enabled/disabled).

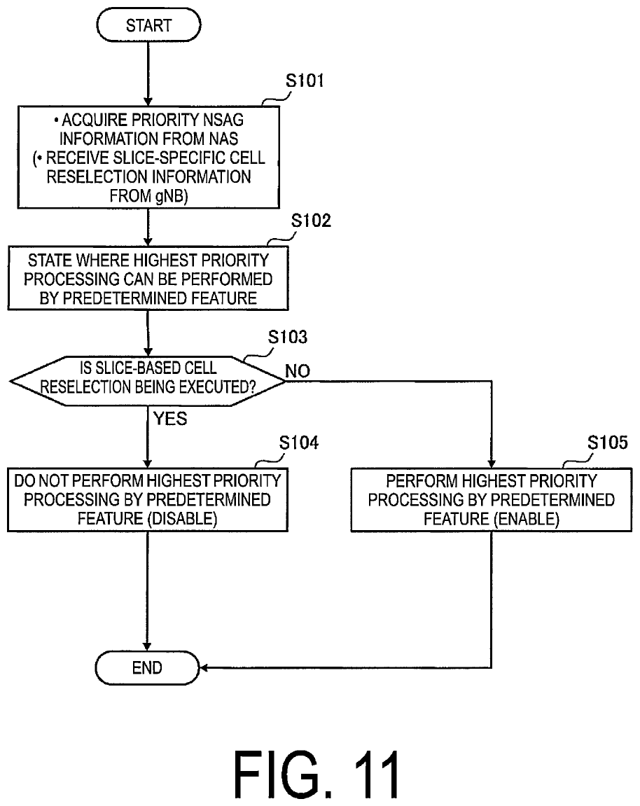

FIG. 11 is a diagram illustrating an operation example of the UE 100 according to the first operation pattern.

In step S101, the UE 100 (AS) is configured with an NSAG priority from the NAS (AMF 300A). The UE 100 may be configured with a slice-specific cell reselection priority from the gNB 200. By acquiring the NSAG priority from the NAS (AMF 300A) and the slice-specific cell reselection priority from the gNB 200, the UE 100 (AS) enters a state where the UE 100 (AS) can execute slice-based cell reselection.

In step S102, the UE 100 (AS) enters a state where the UE 100 (AS) can perform the highest priority processing by the predetermined feature. For example, the UE 100 (AS) may be in one of the following states:
Sidelink (V2X sidelink/NR sidelink): The UE 100 (AS) is configured with sidelink communication or is interested in the sidelink communication,
HSDN: The moving speed of the UE 100 is in a fast moving state, and
MBS: The UE 100 is interested in reception of an MBS session.

That is, in step S102, the UE 100 is in a state where the UE 100 may regard a specific frequency or a specific cell as the highest priority.

In step S103, the UE 100 (AS) checks whether the slice-specific cell reselection priority specified during slice-based cell reselection is applied to the current cell reselection priority. That is, the UE 100 (AS) checks whether (cell reselection accompanying) slice-based cell reselection is being executed. The UE 100 (AS) may check whether the UE 100 (AS) has the priority NSAG information (i.e., whether the priority NSAG information is configured for the UE 100 (NAS) from the AMF 300A).

In a case of YES in step S103, in step S104, the UE 100 (AS) applies (adopts) the slice-specific cell reselection priority of slice-based cell reselection and performs cell reselection without regarding the specific frequency or the specific cell in step S102 as the highest priority. That is, the UE 100 (AS) does not perform the highest priority processing by the predetermined feature.

On the other hand, in a case of NO in step S103, in step S105, the UE 100 (AS) adopts the highest priority processing, regards the specific frequency or the specific cell in step S102 as the highest priority, and performs cell reselection. That is, the UE 100 (AS) performs the highest priority processing by the predetermined feature.

Note that, according to this operation pattern, whether a predetermined cell whose radio quality satisfies a predetermined criterion supports the priority NSAG may be taken into account. The predetermined cell may be a cell (serving cell) that the UE 100 camps on and/or a candidate cell (e.g., highest ranked cell). The UE 100 (AS) may determine that the highest priority processing is applicable in response to the predetermined cell whose radio quality satisfies the predetermined criterion not supporting the priority NSAG. That is, when the highest ranked cell (that may be a currently camping cell) does not support a desired slice (an NSAG having a high priority from the NAS), the UE 100 (AS) may regard a frequency or a cell for providing a predetermined feature as the highest priority. In this case, the UE 100 (AS) may perform frequency priority handling processing again.

### (4.2) Second Operation Pattern

According to the second operation pattern according to the embodiment, whether to permit the highest priority processing by the predetermined feature (i.e., whether to prioritize the highest priority processing by the predetermined feature over the slice-specific cell reselection priority) can be configured for the UE 100 from the gNB 200.

In this operation pattern, in response to reception of the slice-specific cell reselection information indicating the cell reselection priority (slice-specific cell reselection priority) of each NSAG and each frequency from the gNB 200, the UE 100 (AS) performs slice-based cell reselection to which the slice-specific cell reselection information has been applied. The UE 100 (AS) acquires, from the gNB 200 or the NAS (the AMF 300A from another viewpoint), configuration information for configuring whether the highest priority processing of regarding, as the highest priority of cell reselection, a frequency or a cell for providing a predetermined feature different from slice-based cell reselection is applicable. Thus, the UE 100 (AS) can appropriately perform the slice-based cell reselection and/or the highest priority processing under management of the network.

The predetermined feature includes a plurality of features (e.g., the sidelink, the HSDN, and the MBS). The configuration information may be information for configuring per feature whether the highest priority processing is applicable. That is, the gNB 200 (or the AMF 300A) may configure for (notify) the UE 100 (of) whether to permit the highest priority processing per MBS/HSDN/sidelink.

The configuration information may be information for configuring which of the slice-based cell reselection or the highest priority processing to prioritize for cell reselection. The configuration information may be information for configuring a priority order of cell reselection for slice-based cell reselection and each of the plurality of features (e.g., the sidelink, the HSDN, and the MBS) included in the predetermined features.

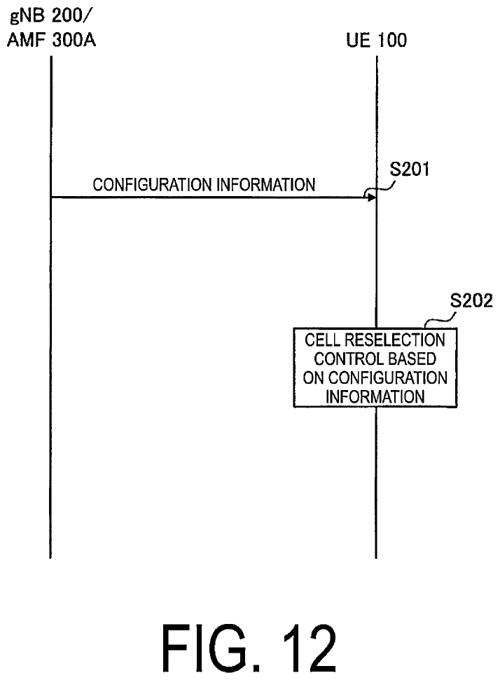

FIG. 12 is a diagram illustrating an operation example of the mobile communication system 1 according to the second operation pattern.

In step S201, the gNB 200 transmits to the UE 100 the configuration information on whether to permit processing of regarding the cell reselection priority as the highest priority. The UE 100 (AS) receives the configuration information. Here, the gNB 200 may include the configuration information in an SIB, an RRC Release message, an RRC Reconfiguration message, or a newly defined message to transmit.

In step S201, the AMF 300A may transmit the configuration information on whether to permit the processing of regarding the cell reselection priority as the highest priority to the UE 100 (NAS) by NAS signaling. In the UE 100, the NAS may notify the AS of the configuration information.

The configuration information includes at least one information of following (a1) to (c1).

(a1) Information indicating whether to permit the highest priority processing:

The information may be information on whether to permit application of the highest priority (i.e., highest priority processing by the predetermined feature) to the cell reselection priority. The information may be information on whether to prioritize the slice-specific cell reselection priority over the highest priority processing. The information may indicate whether to permit application of the highest priority when the slice-specific cell reselection priority (or the NSAG priority by the NAS) is configured.

(b1) Information indicating whether to permit the highest priority processing for each feature:

The information may be, for example, information for configuring whether to permit the highest priority processing for each of the MBS/HSDN/V2X sidelink/NR sidelink.

(c1) Information indicating a priority (priority order) for each feature: The information may be information for configuring the priority order for each of the MBS/HSDN/V2X sidelink/NR sidelink/slice-based cell reselection. Here, the slice-based cell reselection may further be performed according to the priority order of each NSAG. The information may be, for example, information indicating that the NSAG #1 has a higher priority than the MBS, but the NSAG #2 has a lower priority than the MBS. Slice-based cell reselection may further be performed according to a priority order for each slice. The information may be, for example, information indicating that NSSAI #1 has a higher priority than the MBS, but NSSAI #2 has a lower priority lower than the MBS. Note that, as for the NSAG to which the NSSAI belongs, a concept of the priority order of an NSAG immediately above the above NSAG may be applied (appropriated).

The information may be information for configuring whether to prioritize each of the MBS/HSDN/V2X sidelink/NR sidelink over slice-based cell reselection, or information for configuring whether to prioritize the slice-based cell reselection over other features.

In step S202, the UE 100 (AS) performs cell reselection control based on the configuration information received in step S201.

When, for example, the priority of the MBS is configured higher than the slice-based cell reselection, and the UE 100 (AS) regards the MBS frequency as the highest priority, the highest priority is regarded as a priority higher than the cell reselection priorities (0 to 7) of the slice-based cell reselection.

When, for example, the priority of the V2X sidelink is configured lower than that of slice-based cell reselection, and when the UE 100 regards a V2X sidelink frequency as the highest priority, the highest priority is regarded as a priority lower than the cell reselection priority (0 to 7) of the slice-based cell reselection.

When, for example, the cell reselection priority of slice-based cell reselection at a certain frequency is 5, the highest priority of the V2X sidelink frequency is regarded as 4.

### (4.3) Third Operation Pattern

According to the above-described second operation pattern, it is assumed that a feature (user preference) that the UE 100 needs to prioritize is recognized in advance by the gNB 200 and/or the AMF 300A. However, it is also assumed that such an assumption does not hold. It is concerned that, for example, both of the gNB 200 and the AMF 300A do not know from a viewpoint of user experiences whether it is better to prioritize the NSAG (i.e., a feature of using slices such as URLLC) or to prioritize the MBS. Hence, it is concerned that the gNB 200 and/or the AMF 300A may make an inappropriate configuration for the UE 100, and therefore a problem occurs that a user cannot access a feature that the user really needs to prioritize.

According to this operation pattern, the UE 100 transmits, to the network (the gNB 200 or the AMF 300A), preference information indicating a preference of the UE 100 as to which of slice-based cell reselection or the predetermined feature (highest priority processing) to prioritize for cell reselection. The UE 100 (AS) controls slice-based cell reselection and highest priority processing according to the configuration information received from the network based on the preference information. Note that this operation pattern may be an operation performed prior to the operation of the above-described second operation pattern. The preference information may be information indicating a preference of the priority order of cell reselection for slice-based cell reselection and each of the plurality of features (e.g., MBS/HSDN/V2X sidelink/NR sidelink).

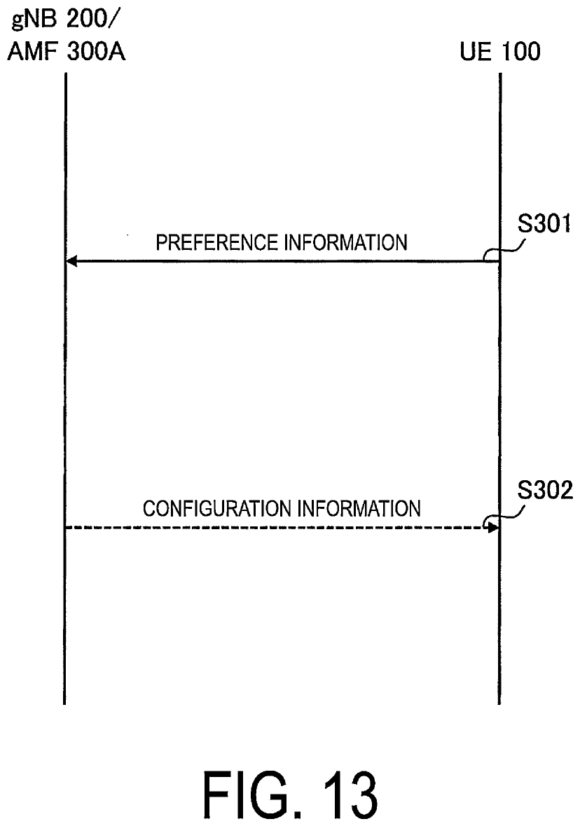

FIG. 13 is a diagram illustrating an operation example of the mobile communication system 1 according to the third operation pattern.

In step S301, the UE 100 (AS) in the RRC connected state transmits preference information indicating a preference of a priority of a feature to the gNB 200. The UE 100 (AS) may include the preference information in an RRC message such a UE Assistance Information message, an MBS Interest Indication message, or a newly defined message to transmit. In step S301, the UE 100 (NAS) may transmit the preference information to the AMF 300A by NAS signaling.

The preference information includes at least one information of following (a2) to (c2).

(a) Information indicating a priority for each feature:

The information may be, for example, a priority order of each of the MBS/HSDN/V2X sidelink/NR sidelink/slice-based cell reselection. Note that slice-based cell reselection may be regarded as a slice-based cell reselection feature or may be regarded as a feature assigned to each slice configured during slice-based cell reselection.

Slice-based cell reselection may be further performed per NSAG. The information may be, for example, information indicating that the NSAG #1 has a higher priority than the MBS, but the NSAG #2 has a lower priority than the MBS. The information may be information that indicates that the NSAG #1 may perform the highest priority processing and the NSAG #2 does not permit the highest priority processing.

Slice-based cell reselection may be further performed per slice. The information may be, for example, information indicating that NSSAI #1 has a higher priority than the MBS, but NSSAI #2 has a lower priority lower than the MBS. As for the NSAG to which the NSSAI belongs, the concept of the priority order of an NSAG immediately above the above NSAG may be applied (appropriated).

When, for example, prioritization of a slice for V2X (=a slice whose slice type is V2X) is configured, processing of regarding a frequency for providing the V2X feature as the highest priority may be performed (it may be regarded that the processing is permitted). Additionally, when, for example, the MBS and/or the HSDN are defined as slice types, frequencies for providing the features designated by the slice types may be regarded as the highest priority likewise. That is, it may be permitted to regard the frequency for providing the associated feature as the highest priority based on the slice type and the priority of each slice.

(b2) Information indicating whether it is necessary to perform the highest priority processing for each feature:

The information may be, for example, information indicating a preference as to whether it is necessary to perform the highest priority processing for each of the MBS/HSDN/V2X sidelink/NR sidelink.

(c2) Information indicating a priority (priority order) for each feature: The information may be information indicating a preference of the priority order for each of the MBS/HSDN/V2X sidelink/NR sidelink/slice-based cell reselection.

In the UE 100, an upper layer (an application or the NAS) may notify the AS of the priority information for each feature.

The priority information for each feature may be notified from the AMF 300A to the UE 100 (NAS). In the UE 100, the priority order information notified from the NAS to the AS may be notified from the AS to the gNB 200.

The gNB 200 having received the preference information in step S301 may store the preference information as a UE context. In response to the preference information, the gNB 200 may transmit to the UE 100 a response (configuration) as to whether to give a permission. When, for example, permission is configured using the RRC Reconfiguration message or the RRC Release message, the UE 100 (AS) may perform processing of specifying a cell reselection priority according to permission information after transitioning to the RRC idle state or the RRC inactive state.

In step S302, the gNB 200 may perform cell reselection-related configuration for the UE 100 (AS) based on the preference information received in step S301. For example, the gNB 200 may configure the cell reselection priority of slice-based cell reselection using the RRC release message.

### (4.4) Fourth Operation Pattern

According to this operation pattern, the UE 100 is configured to prioritize a feature (e.g., the V2X sidelink communication or the MBS) that the UE 100 is interested in during slice-based cell reselection. SST in the NSAG/S-NSSAI notified from the NAS to the AS in the UE 100 includes standards-defined and operator-defined service type information. When the service indicated by the SST corresponds to a feature that the UE 100 (AS) needs to regard as the highest priority, the UE 100 (AS) regards as the highest priority the cell reselection priority of the frequency for providing the service or regards the NSAG priority of the NSAG as the highest priority. Thus, both of the slice-based cell reselection and the highest priority processing can be achieved.

That is, according to this operation pattern, the UE 100 (AS) acquires priority NSAG information indicating a priority NSAG from the NAS. The UE 100 (AS) checks whether information indicating the predetermined feature (more specifically, the feature that the UE 100 is interested in) is included in any one of the NSAGs indicated by the priority NSAG information from the NAS. When the information indicating the predetermined feature is included in any one of the NSAGs, the UE 100 (AS) regards as the highest priority of cell reselection the NSAG including the information indicating the predetermined feature or the frequency for providing the predetermined feature.

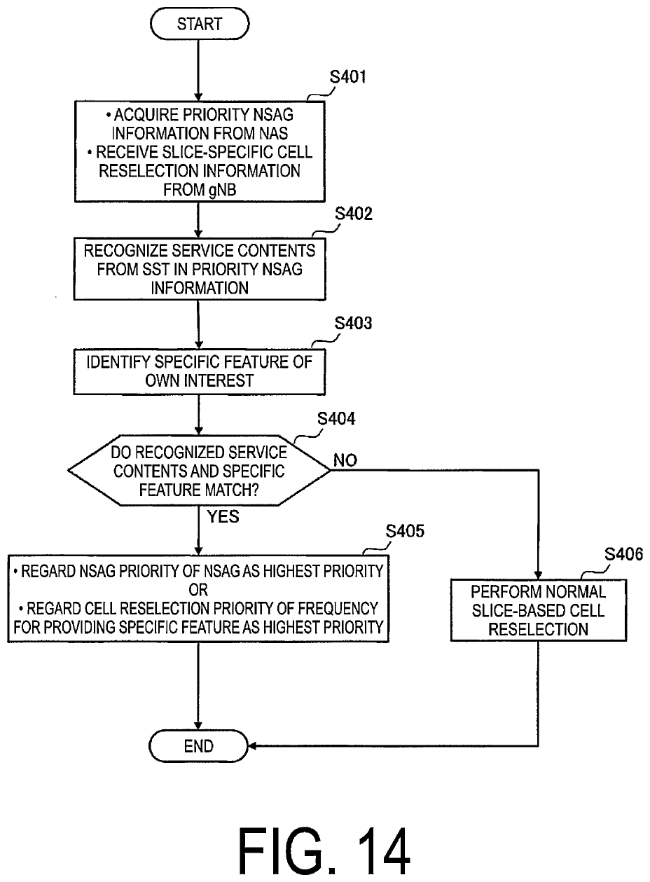

FIG. 14 is a diagram illustrating an operation example of the UE 100 according to the fourth operation pattern.

In step S401, the UE 100 (AS) acquires the priority NSAG information from the NAS. The UE 100 (AS) receives slice-specific cell reselection information from the gNB 200.

In step S402, the UE 100 (AS) checks S-NSSAI in each NSAG included in the priority NSAG information acquired in step S401, and recognizes the service contents from the SST in the S-NSSAI.

In step S403, the UE 100 (AS) identifies a specific feature (e.g., the MBS or the V2X sidelink communication) that the UE 100 (AS) is interested in.

In step S404, the UE 100 (AS) checks whether the specific feature identified in step S403 matches with any one of the service contents recognized in step S402.

In a case of YES in step S404, in step S405, the UE 100 (AS) may regard as the highest priority the NSAG priority of the NSAG including the matching service contents. In this case, the UE 100 (AS) may apply to each frequency the cell reselection priority of slice-based cell reselection corresponding to the NSAG, and perform cell reselection.

In step S405, as for the NSAG whose NSAG priority is the highest, when the SST (service contents) of the S-NSSAI in the NSAG matches with the specific feature identified in step S403, the UE 100 (AS) may regard as the highest priority the frequency for providing the specific feature based on the slice-specific cell reselection information, and perform cell reselection.

On the other hand, in a case of NO in step S404, in step S406, the UE 100 (AS) may perform normal slice-based cell reselection defined in the current technical specifications.

### (4.5) Fifth Operation Pattern

According to this operation pattern, the UE 100 (AS) identifies the frequency for which the cell reselection priority is configured in the slice-specific cell reselection information received from the gNB 200 for the highest priority NSAG indicated by the priority NSAG information acquired from the NAS. Among the identified frequencies, the UE 100 (AS) regards as the highest priority of cell reselection the frequency for providing the predetermined feature that the UE 100 (AS) is interested in. Thus, both of the slice-based cell reselection and the highest priority processing can be achieved.

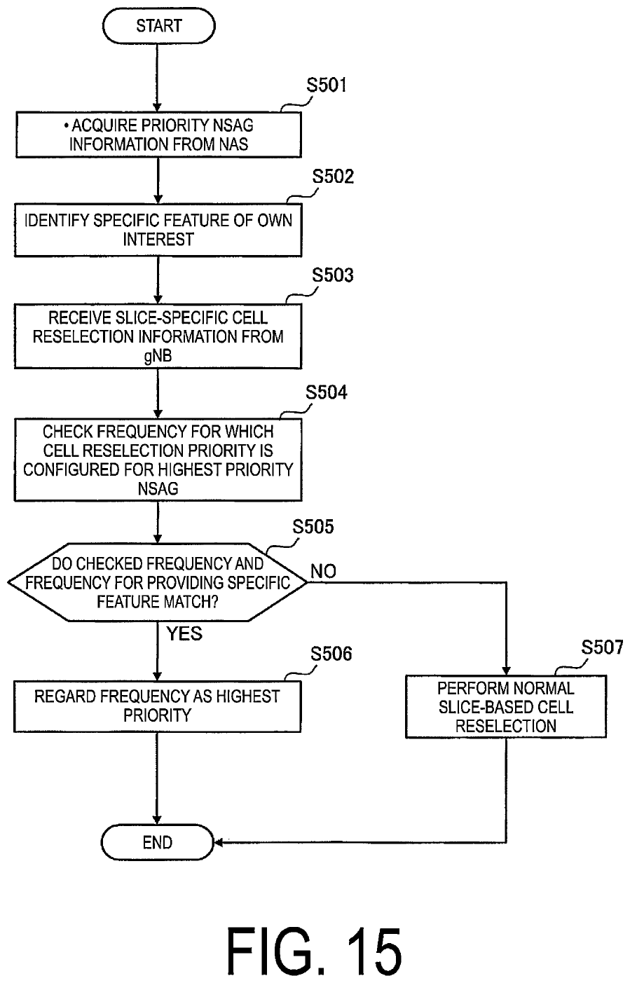

FIG. 15 is a diagram illustrating an operation example of the UE 100 according to the fifth operation pattern.

In step S501, the UE 100 (AS) acquires the priority NSAG information from the NAS.

In step S502, the UE 100 (AS) identifies the specific feature (e.g., the MBS or the V2X sidelink communication) that the UE 100 (AS) is interested in.

In step S503, the UE 100 (AS) receives the slice-specific cell reselection information in, for example, the SIB 16 from the gNB 200.

In step S504, for the highest priority NSAG indicated by the priority NSAG information acquired from the NAS, the UE 100 (AS) checks the frequency for which the cell reselection priorities is configured, based on the slice-specific cell reselection information.

In step S505, the UE 100 (AS) checks whether the frequency checked in step S504 matches with the frequency for providing the specific feature identified in step S502. In a case of YES in step S505, in step S506, the UE 100 (AS) regards the cell reselection priority of the frequency as the highest priority.

On the other hand, in a case of NO in step S505, in step S507, the UE 100 (AS) may perform normal slice-based cell reselection defined in the current technical specifications. Here, the UE 100 (AS) determines that the highest priority processing is not applied, and applies the cell reselection priority of the slice-based cell reselection to each frequency.

### (5) Other Embodiment

In the embodiment, the processing example of the highest priority has been described. However, the present disclosure may be applied to processing of a lowest priority. The above-described operation flows can be separately and independently implemented, and also be implemented in combination of two or more of the operation flows. For example, some steps of one operation flow may be added to another operation flow or some steps of one operation flow may be replaced with some steps of another operation flow. In each flow, all steps do not need to be necessarily executed, and only some of the steps may be executed.

In the above-described embodiment and example, an example where the base station is an NR base station (i.e., gNB) has been described. However, the base station may be an LTE base station (i.e., eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may mean a device of a core network or a part of a base station (the CU, the DU or the RU).

A program that causes a computer to execute each processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing each performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on/in response to” used in the present disclosure do not mean “based only on” and “only depending on/in response to”, unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiment has been described above in detail with reference to the drawings, but specific configurations are not limited to those described above, and various design variation can be made without departing from the gist of the present disclosure.

### (6) Supplementary Note

Features relating to the embodiment described above will be described below as supplements.

### Supplementary Note 1

A cell reselection method used in a user equipment includes the steps of:
performing slice-based cell reselection in response to a user equipment receiving, from a network node, slice-specific cell reselection information indicating a cell reselection priority of each slice group and each frequency; and
determining whether highest priority processing is applicable based on whether the slice-based cell reselection to which the slice-specific cell reselection information is applied is being performed, the highest priority processing regarding a frequency or a cell for providing a predetermined feature different from the slice-based cell reselection as a highest priority of cell reselection.

### Supplementary Note 2

The cell reselection method described in Supplementary Note 1 further includes acquiring priority slice group information indicating a priority slice group from a Non-Access Stratum (NAS),
wherein the determining includes determining, when the slice-specific cell reselection information has not been received from the network node, that the highest priority processing is applicable even when the priority slice group information is acquired from the NAS.

### Supplementary Note 3

The cell reselection method described in Supplementary Note 1 or 2 further includes determining that the highest priority processing is applicable in response to a predetermined cell whose radio quality satisfies a predetermined criterion not supporting the priority slice group.

### Supplementary Note 4

A cell reselection method used in a user equipment includes the steps of:
performing slice-based cell reselection to which slice-specific cell reselection is applied, in response to a user equipment receiving, from a network node, the slice-specific cell reselection information indicating a cell reselection priority of each slice group and each frequency; and acquiring, from the network node or a Non-Access Stratum (NAS), configuration information for configuring whether highest priority processing is applicable, the highest priority processing regarding a frequency or a cell for providing a predetermined feature different from the slice-based cell reselection as a highest priority of cell reselection.

### Supplementary Note 5

The cell reselection method according to Supplementary Note 4, wherein
the predetermined feature includes a plurality of features, and
the configuration information is information for configuring for each of the plurality of features whether the highest priority processing is applicable.

### Supplementary Note 6

The cell reselection method according to Supplementary Note 4, wherein the configuration information is information for configuring which of the slice-based cell reselection or the highest priority processing to prioritize for the cell reselection.

### Supplementary Note 7

The cell reselection method according to Supplementary Note 4, wherein
the predetermined feature includes a plurality of features, and
the configuration information is information for configuring a priority order of the cell reselection for the slice-based cell reselection and each of the plurality of features included in the predetermined feature.

### Supplementary Note 8

A cell reselection method used in a user equipment includes the steps of:
transmitting, to a network, preference information indicating a preference of a user equipment as to which of slice-based cell reselection or a predetermined feature different from the slice-based cell reselection to prioritize for cell reselection; and
controlling the slice-based cell reselection and highest priority processing according to configuration information received from the network based on the preference information, the highest priority processing regarding a frequency or a cell for providing the predetermined feature as a highest priority of cell reselection.

### Supplementary Note 9

The cell reselection method according to Supplementary Note 8, wherein
the predetermined feature includes a plurality of features, and
the preference information is information indicating a preference of a priority order of the cell reselection for the slice-based cell reselection and each of the plurality of features.

### Supplementary Note 10

A cell reselection method used in a user equipment includes the steps of:
acquiring priority slice group information indicating a priority slice group from a Non-Access Stratum (NAS);
checking whether information indicating a predetermined feature different from the slice-based cell reselection is included in any one of slice groups indicated by the priority slice group information; and
regarding the slice group including the information indicating the predetermined feature or a frequency for providing the predetermined feature as a highest priority of cell reselection, in response to the information indicating the predetermined feature being included in any one of the slice groups.

### Supplementary Note 11

A cell reselection method used in a user equipment includes the steps of:
acquiring priority slice group information indicating a priority slice group from a Non-Access Stratum (NAS);
executing a predetermined feature different from the slice-based cell reselection; receiving, from a network node, slice-specific cell reselection information indicating a cell reselection priority of each slice group and each frequency; and
regarding a frequency for providing the predetermined feature as a highest priority of cell reselection among frequencies for which the cell reselection priority is configured in the slice-specific cell reselection information for a highest priority slice group indicated by the priority slice group information.

### Supplementary Note 12

The cell reselection method according to any one of Supplementary Notes 1 to 11, wherein the predetermined feature includes at least one selected from the group consisting of Multicast/Broadcast Services (MBS), a V2X sidelink, an NR sidelink, and a High Speed Dedicated Network (HSDN).

### (7) Supplementary Note

Supplementary matters relating to the above-described embodiment will be described as supplements.

### INTRODUCTION

It is necessary for RAN2 #119e to further study whether/how to handle a cell reselection priority from viewpoints of a “highest priority rule of an MBS or an HSDN” and a “slice-specific cell reselection priority”.

### (1) Between MBS and Slice-Specific Cell Reselection

It is necessary to further study whether a frequency priority order determination procedure of the MBS is influenced by the priority order of slice-based reselection.

(2) Between HSDN and Slice-Specific Cell Reselection 19: Coexistence of an HSDN and slice-specific cell reselection is postponed (how this works in this release is unknown).

This supplementary note discusses the coexistence of cell reselection between a highest priority rule and a slice-specific cell reselection priority.

### DISCUSSION

A summary of the highest priority rule of TS38.304 is as follows.

TABLE 1

| Functionality | Behavior |
|---|---|
| HSDN | When a UE that supports the HSDN is in a fast moving |
| | state, the UE needs to consider an HSDN cell as the |
| | highest priority at all times (i.e., the highest priority is |
| | higher than priorities configured by any other networks). |
| V2X | The UE may regard frequencies for providing both of an |
| Sidelink & | NR sidelink communication configuration and a V2X |
| NR Sidelink | sidelink communication configuration as the highest |
| | priority. |
| V2X | The UE may regard the frequencies for providing the V2X |
| Sidelink | sidelink communication configuration as the highest |
| | priority. |
| NR Sidelink | The UE may regard the frequencies for providing the NR |
| | sidelink communication configuration as the highest |
| | priority. |
| MBS | As defined in TS38.300, the UE may regard as the highest |
| | priority a frequency during an MBS broadcast session as |
| | long as following two conditions are satisfied. |

Note:
Priority handling between frequencies regarded as the highest priority frequency by the UE is up to implementation of the UE.

Observation 1: In the current specifications, an HSDN cell is regarded as the highest priority, and the V2X sidelink/NR sidelink/MBS frequencies are regarded as the highest priorities.

Observation 2: According to current specifications, the highest priority means that the highest priority is higher than any other priorities (i.e., 0 to 7) configured by the networks.

It is defined for the HSDN to assist a specific network policy that, for example, the HSDN cell is disposed along a high-speed railway, and the UE in the fast moving state prioritizes the HSDN cell and performs cell reselection.

On the other hand, as for the V2X sidelink, the NR sidelink, and the MBS frequency, user selection is assisted. When, for example, the user is interested in the MBS services, the UE will prioritize the MBS frequency that the UE is interested in.

Observation 3: Although selection of the HSDN cell is determined according to the network policy, selection of the V2X sidelink/NR sidelink/MBS frequency is determined according to a user's preference.

For slice-specific cell reselection, an NSAG priority is configured by the AMF, and an NSAG frequency priority is configured by the gNB and therefore is considered to assist the network policy.

Observation 4: The cell reselection priority per slice is determined according to the network policy.

Particularly when the UE is in an idle/inactive state, it is difficult for the network to recognize the latest user preference, and therefore it is considered to be necessary to prioritize the user preference over the network policy. When, for example, the user is interested in reception of the MBS service, the UE needs to camp on a cell/frequency for providing the MBS services. It is difficult to guide such a UE to the cell/frequency by, for example, slice-specific cell reselection in consideration of that the user preference changes from time to time. Hence, it is necessary for RAN2 to check that user's selection is prioritized over the network policy at all times as is currently prioritized.

Observation 5: It may be difficult for the network to recognize the latest user preferences particularly when the UE is in the idle/inactive state.

Proposal 1: It is necessary for RAN2 to check that the user's priority order is prioritized over the current network policy, that is, highest priority rules of V2X and the MBS do not need to be changed.

On the other hand, as for priority handling in the network policy, that is, priority handling between the HSDN and slice-specific cell reselection, how the UE operates is completely up to the network. Although it may be better in a case of some deployments to prioritize the HSDN over the slice-specific cell reselection, the opposite may also apply in a case of different deployments. Hence, according to a compromise, the network may indicate to the UE which feature needs to be prioritized, i.e. which priority order of slice-specific cell reselection or highest priority of the HSDN needs to be prioritized.

Observation 6: Priority handling in the network policy is up to the network, and whether to prioritize the slice-specific cell reselection priority over the highest priority of the HSDN or prioritize the highest priority of the HSDN over the slice-specific cell reselection priority is up to an operation.

Proposal 2: The gNB indicates to the UE which slice-specific cell reselection priority or the HSDN cell of the highest priority needs to be prioritized.

### REFERENCE SIGNS

1: Mobile communication system
10: RAN
20: CN
100: UE (user equipment)
110: Receiver
120: Transmitter
130: Controller
200: gNB (base station)
210: Transmitter
220: Receiver
230: Controller
240: Backhaul communicator

1. A cell reselection method used in a user equipment, the cell reselection method comprising the steps of:
performing slice-based cell reselection in response to the user equipment receiving, from a base station, slice-specific cell reselection information indicating a cell reselection priority for each slice group and each frequency; and
performing processing of regarding a frequency configured to provide a predetermined feature as a highest priority of cell reselection without taking into account the cell reselection priority indicated by the slice-specific cell reselection information, when the predetermined feature different from the slice-based cell reselection is configured for the user equipment or when the user equipment is interested in executing the predetermined feature.

2. The cell reselection method according to claim 1, further comprising:
performing processing of regarding a frequency configured to provide a High Speed Dedicated Network (HSDN) as the highest priority of cell reselection with further priority over the processing of regarding the frequency configured to provide the predetermined feature as the highest priority of cell reselection.

3. The cell reselection method according to claim 2, wherein the predetermined feature comprises at least one selected from the group consisting of MBS (Multicast/Broadcast Services), NR sidelink, and V2X sidelink.

4. A user equipment comprising:
a receiver configured to receive, from a base station, slice-specific cell reselection information indicating a cell reselection priority for each slice group and each frequency; and
a controller configured to perform slice-based cell reselection in response to reception of the slice-specific cell reselection information,
wherein the controller is configured to perform processing of regarding a frequency configured to provide a predetermined feature as a highest priority of cell reselection without taking into account the cell reselection priority indicated by the slice-specific cell reselection information, when the predetermined feature different from the slice-based cell reselection is configured for the user equipment or when the user equipment is interested in executing the predetermined feature.

5. A system comprising:
a user equipment; and
a base station,
wherein the user equipment comprises:
a receiver configured to receive, from the base station, slice-specific cell reselection information indicating a cell reselection priority for each slice group and each frequency; and
a controller configured to perform slice-based cell reselection in response to reception of the slice-specific cell reselection information,
wherein the controller is configured to perform processing of regarding a frequency configured to provide a predetermined feature as a highest priority of cell reselection without taking into account the cell reselection priority indicated by the slice-specific cell reselection information, when the predetermined feature different from the slice-based cell reselection is configured for the user equipment or when the user equipment is interested in executing the predetermined feature, and
wherein the base station comprises:
a transmitter configured to transmit the slice-specific cell reselection information to the user equipment.

6. A non-transitory computer-readable medium storing instructions that, when executed by a processor of a user equipment, cause the processor to perform the cell reselection method according to claim 1.

7. A chipset for controlling a user equipment, the chipset comprising a processor and a memory, wherein the processor executes the cell reselection method according to claim 1.
